(19) United States
(12) Patent Application Publication
(10) Pub. No.: US 2013/0220366 A1
(43) Pub. Date: Aug. 29, 2013

(54) METHOD FOR SURFACE DECONTAMINATION

(71) Applicants: RAINER GASSEN, FUERTH (DE); BERTRAM ZEILER, BISCHBERG (DE)

(72) Inventors: RAINER GASSEN, FUERTH (DE); BERTRAM ZEILER, BISCHBERG (DE)

(73) Assignee: AREVA NP GMBH, ERLANGEN (DE)

(21) Appl. No.: 13/592,462

(22) Filed: Aug. 23, 2012

Related U.S. Application Data
(63) Continuation of application No. PCT/EP2011/056580, filed on Apr. 26, 2011.

(30) Foreign Application Priority Data
Apr. 30, 2010 (DE) 10 2010 028 457.2

(51) Int. Cl. G21F 9/00; B08B 3/08

(52) U.S. Cl. CPC G21F 9/004; B08B 3/08
USPC 134/3

(57) ABSTRACT

A method for chemical decontamination of an oxide-coated surface of a metal structural part or of a system in a nuclear power plant with several cleaning cycles, involves oxidation steps, in which the oxide layer is treated with an aqueous solution containing an oxidation agent, and a subsequent decontamination step, in which the oxide layer is treated with an aqueous solution of an acid. At least one oxidation step is carried out in an acid solution and at least one oxidation step in an alkaline solution.

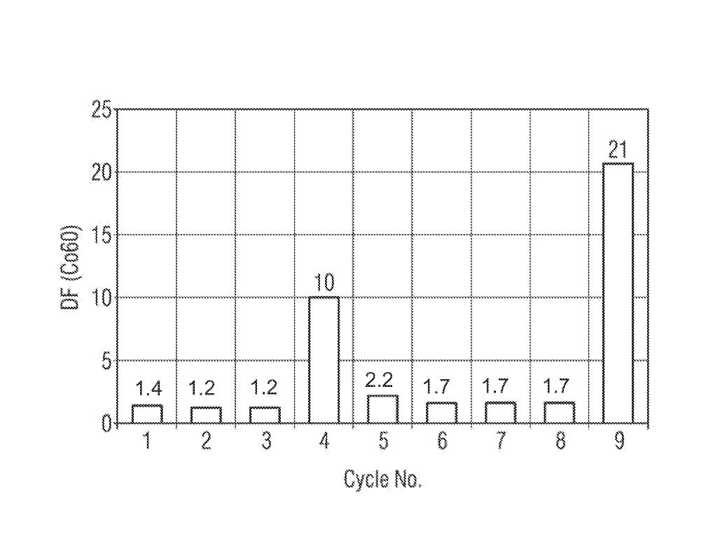

### CROSS-REFERENCE TO RELATED APPLICATION

This application is a continuation application, under 35 U.S.C. §120, of copending international application No. PCT/EP2011/056580, filed Apr. 26, 2011, which designated the United States; this application also claims the priority, under 35 U.S.C. §119, of German patent application No. DE 10 2010 028 457.2, filed Apr. 30, 2010; the prior applications are herewith incorporated by reference in their entireties.

### BACKGROUND OF THE INVENTION

### Field of the Invention

The invention relates to a process for the surface decontamination of components or systems of a nuclear power station, for example of a pressurized water reactor (PWR). The key part of a nuclear power station is a reactor pressure vessel in which fuel elements containing nuclear fuel are arranged. A piping system which forms the coolant circuit is connected to the reactor pressure vessel and is in the case of a PWR connected to at least one coolant pump and a steam generator.

Under the conditions of power output operation of a nuclear reactor at temperatures of up to 288° C., even stainless austenitic FeCrNi steels of which, for example, the piping system of the coolant circuit of a PWR consists, Ni alloys of which, for example, the heat exchanger tubes of steam generators consist and other, e.g. cobalt-containing, components used, for example, for coolant pumps display a certain solubility in water. Metal ions leached from the alloys mentioned go with the coolant stream to the reactor pressure vessel where they are partly converted into radioactive nuclides by the neutron radiation prevailing there. The nuclides are in turn distributed over the entire coolant system by the coolant stream and are incorporated in oxide layers which are formed on the surfaces of components of the coolant system during operation. With increasing time of operation, the amount of the deposited activated nuclides adds up and the radioactivity or the dosage output of the components of the coolant system therefore increases. Depending on the type of alloy used for a component, the oxide layers contain, as main constituent, iron oxide with divalent and trivalent iron and oxides of other metals, especially chromium and nickel, which are present as alloy constituents in the abovementioned steels. Nickel is always present in divalent form (Ni²⁺) and chromium is always present in trivalent form (Cr³⁺).

Before monitoring, maintenance, repair and retreating working measures can be carried out on the coolant system, it is necessary to reduce the radioactivity of the respective components in order to reduce the radiation exposure of personnel. This is achieved by removing the oxide layer present on the surfaces of the components as completely as possible by a decontamination process. In such decontamination, either the entire coolant system or a part which has been isolated therefrom by means of, for example, valves is filled with an aqueous cleaning solution or individual components of the system are treated in a separate vessel containing the cleaning solution. In the case of chromium-containing components, for instance in the case of a pressurized water reactor, the oxide layer is first treated oxidatively (oxidation step) and the oxide layer is subsequently dissolved under acidic conditions. This process step, which will hereinafter be referred to as decontamination step, is often also carried out under reductive conditions. The oxidant used in the preceding oxidation step is therefore removed or neutralized, as indicated below. The oxidative treatment of the oxide layer is necessary because chromium(III) oxides and mixed oxides containing trivalent chromium, especially of the spinel type, dissolve only with difficulty in the decontamination acids, e.g. oxalic acid, used for decontamination. To increase the solubility, the oxide layer is therefore first treated with an aqueous solution of an oxidant such as Ce⁴⁺, HMnO₄, H₂S₂O₈, KMnO₄ or O₃. The result of this treatment is that Cr(III) is oxidized to Cr(VI) which goes into solution as CrO₄²⁻. The cleaning solution present at the end of an oxidative treatment is either discarded or worked up so that it can be used in the decontamination step. When the latter is the case, a residual content of oxidant has to be removed or neutralized by a reducing agent by, for example, using an appropriate excess of acid.

The decontamination step following the oxidation serves to dissolve the previously oxidatively treated oxide layer by a complexing organic acid or mixtures of such acids. Such a decontamination acid can, as mentioned above, simultaneously serve to neutralize the oxidant used in the oxidation step. However, it is also possible to reduce or neutralize an oxidant such as HMnO₄ by a reducing agent additionally added to the decontamination acid, for example ascorbic acid, citric acid or hydrogen peroxide. The Cr(VI) formed in the oxidation step is thereby reduced back to Cr(III). At the end of a decontamination step, Cr(III), Fe(II), Fe(III), Ni(II), inter alia, and also radioactive isotopes such as Co-60 are present in the cleaning solution. These metal ions can be removed from the cleaning solution by an ion exchanger.

In general, a plurality of treatment cycles containing an oxidation step and a decontamination step are carried out in order to achieve satisfactory cleaning success, i.e. to achieve a very high decontamination factor. The decontamination factor is the ratio of the initial value of the radioactive radiation emitted by a component or system surface or the oxide layer present thereon measured before carrying out a cleaning cycle and the final value of this radiation present at the end of the cleaning cycle.

### SUMMARY OF THE INVENTION

It is accordingly an object of the invention to provide a process for surface decontamination which overcomes the above-mentioned disadvantages of the prior art methods of this general type, which has improved effectiveness.

The object is achieved by a process of the type mentioned at the outset, in which at least one oxidation step is carried out in acidic solution and at least one oxidation step is carried out in alkaline solution. It has been found that changing the pH of the oxidation solution from the acidic range to the alkaline range or vice versa, such a change will hereinafter be referred to as pH change, brings about an increase in the decontamination factor. The pH change can be carried out in one and the same cleaning cycle. However, preference is given to carrying out an oxidation step in acidic or alkaline solution in one cleaning cycle and carrying out an oxidation step in alkaline or acidic, respectively, solution in a subsequent cleaning cycle. If the acidic or alkaline conditions after a pH change are maintained in subsequent oxidation steps, there is no significant increase in the decontamination factor. This is the case only when a pH change occurs in a subsequent oxidation step. A particularly significant increase in the decontamination factor after a pH change is achieved when a pH of less than 6, preferably less than 4, is adhered to in the case of the acidic oxidation and a pH of more than 8, preferably more than 10, is adhered to in the alkaline oxidation.

As oxidants, preference is given to using O₃, in dissolved or gaseous form, S₂O₈²⁻, for example as Na salt, and cerium(IV) compounds, but specially HMnO₄ and KMnO₄ in acidic (preferably nitric acid) solution and KMnO₄ in alkaline solution, in particular with NaOH as alkalizing agent.

Other features which are considered as characteristic for the invention are set forth in the appended claims.

Although the invention is illustrated and described herein as embodied in a method for surface decontamination, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

The single FIGURE of the drawing is a graph showing varying pH values while performing a plurality of cleaning cycles.

### DETAILED DESCRIPTION OF THE INVENTION

In a process of the type provided by the invention, as described at the outset, an oxide layer present on a component of a nuclear power station is at least partly removed by treating the oxide layer or the component in a plurality of cleaning cycles. For decontamination of a total system, for instance a coolant system of a pressurized or boiling water reactor, this is filled with the respective cleaning solutions. The system serves effectively as its own container. If, on the other hand, single components are decontaminated, a container in which the component is treated with the appropriate cleaning solutions is used for this purpose. An oxidation of the oxide layer is first carried out in order to oxidize chromium(III) present therein to chromium(VI). As oxidant, it is in principle possible to use all oxidants which are able to oxidize chromium(III) to chromium(VI), for example ozone, peroxodisulfate, cerium(IV) oxide and permanganic acid or permanganate. The oxidation is advantageously carried out at elevated temperature, for instance 80-95° C. After a residence time of, for example, a plurality of hours, the cleaning solution is replaced or, for example as described above, treated in such a way that it can be used in the subsequent decontamination step. For the decontamination, preference is given to using, in particular, organic acids such as oxalic acid, citric acid, ascorbic acid and the like. A residue of oxidant still present in the solution of the oxidation step is neutralized by an appropriate excess of decontamination acid. The metal ions leached from the oxide layer are, likewise in a manner known per se, removed by an ion exchanger. When this is the case to a sufficient extent, a new cleaning cycle is started, with the pH of the oxidation solution being changed from acidic to alkaline or vice versa in this or a later cleaning cycle. In the acidic range, pH values of less than 6, preferably less than 4, are adhered to. In the basic range, the pH values are greater than 8, preferably greater than 10. The consequences of a change between oxidation steps of the above-described type carried out differently is that a significant increase in the decontamination factor compared to the radioactivity of the oxide layer of the preceding cycle is achieved. If a pH change is carried out within a cleaning cycle, i.e. for example after an oxidation step in acidic solution, an oxidation step in alkaline solution is carried out by replacing the acidic solution by an alkaline solution containing the oxidant or converting it into such a solution, an increase in the decontamination factor compared to a cleaning cycle in which a plurality of oxidation steps are carried out but these are carried out without a pH change is achieved.

The accompanying graph shows the result of an experiment in which a specimen has been decontaminated in the manner according to the invention. The specimen originated from a coolant pipe which had been in use for a number of years. To obtain the specimen, a radial cylinder was cut from the pipe and the side of this which had formed the previous pipe exterior and its circumferential surface were provided with a protective layer so that only the end face of the radial cylinder, which corresponds to the previous interior of the pipe, was accessible to the cleaning solutions. The pipe and the specimen consisted of type AISI 316 L steel. The oxide layer contained about 50% of iron, 40% of chromium and 10% of nickel, based on the total content of metals. The radioactivity, which was due essentially to the presence of cobalt-60 in the oxide layer, was 2.4*10⁵ becquerel. The oxide layer and the end face of the specimen bearing it had an area of 5.3 cm². A total of 9 cleaning cycles were carried out in containers having a capacity of about one liter. In the first three cycles, an oxidation in an acidic medium using permanganic acid having a concentration of 0.3 g/l and a temperature of 95° C. was carried out. A pH of about 3 was established here. The duration of the oxidation was about 17 hours. The remaining reaction solution was then replaced by an oxalic acid solution having a concentration of 2 g/l and the oxide layer was treated therewith for about 5 hours at a temperature of 95° C. Two further cycles of the type described were then carried out.

In the fourth cycle, the conditions in the oxidation step were changed. The treatment was now carried out in the alkaline range using 1.6 g/l of potassium permanganate and 1.6 g/l sodium hydroxide. The duration of the treatment and the temperature of the treatment solutions were the same as described above. Compared to cycle 3, a distinct increase in the decontamination factor to a value of 10 was observed. Cycles 5-8 were carried out under the same conditions as cycle 4. It was found that the decontamination factors achieved in each case were far below that achieved in cycle 4. In cycle 9, a change was finally made to an oxidation step in the acidic range, with the abovementioned conditions being maintained. Here, there was an even more significant increase in the decontamination factor compared to the preceding cycle 8 to a value of 21.

1. A process for chemical decontamination of a surface having an oxide layer of a metallic component or of a system of a nuclear power station, which comprises the steps of:
performing a plurality of cleaning cycles each containing oxidation steps in which the oxide layer is treated with an aqueous solution having an oxidant and a subsequent decontamination step in which the oxide layer is treated with an aqueous solution of an acid, wherein at least one of the oxidation steps is carried out in an acidic solution and at least one of the oxidation steps is carried out in an alkaline solution; and
selectin the oxidant from the group consisting of O₃, S₂O₈²⁻ and a cerium(IV) compound for use in the oxidation steps.

2. The process according to claim 1, which further comprises setting a pH of the acidic solution to be <6 and a pH of the alkaline solution to be >8.

3. The process according to claim 2, which further comprises setting a pH of the acidic solution to be <4 and a pH of the alkaline solution of >10.

4. (canceled)

5. The process according to claim 1, which further comprises selecting the oxidant from the group consisting of HMnO₄, HMnO₄ with HNO₃, and KMnO₄ with HNO₃ for use in an oxidation step in the acidic solution.

6. The process according to claim 1, which further comprises using KMnO₄ together with an alkalizing agent for an oxidation step in the alkaline solution.

7. The process according to claim 6, which further comprises using NaOH as the alkalizing agent.
